(19) United States
(12) Patent Application Publication
(10) Pub. No.: US 2009/0080807 A1
(43) Pub. Date: Mar. 26, 2009

(54) Image Processing System and Image Processing Apparatus

(75) Inventors: Takayoshi KOJIMA, Azumino-shi (JP); Yoichi TANAKA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/210,033

(22) Filed: Sep. 12, 2008

(30) Foreign Application Priority Data
Sep. 26, 2007 (JP) 2007-249943

(51) Int. Cl. G06K 9/60

(52) U.S. Cl. 382/307

(57) ABSTRACT

A raw image data creating unit that creates a raw image data; an image file creating unit capable of creating an image file conforming to a predetermined format based on the created raw image data; and a control unit for determining based on a predetermined criterion whether an external apparatus is caused to execute at least part of a process for creating the image file based on the raw image data, outputting the raw image data or halfway processed data obtained when the image file creating unit is caused to execute the process halfway to the external apparatus, instructing the external apparatus to create the image file based on the raw image data or the halfway processed data if the control unit determines that the external apparatus is caused to execute it, and causing the image file creating unit to execute creating the image file if the control unit determines that the external apparatus is not caused to execute it.

The entire disclosure of Japanese Patent Application No. 2007-249943, filed Sep. 26, 2007, is expressly incorporated by reference herein.

### BACKGROUND

1. Technical Field

The present invention an image processing technique whereby to create an image file.

2. Related Art

When an object is photographed using a digital still camera (hereinafter abbreviated to DSC), the DSC performs a process in which a PAW data captured by an image pickup device is developed and compressed according to a predetermined compression format and the compressed image file is stored in a recording medium inserted into the DSC. Japanese Patent Application Laid-Open No. 2005-159995 (Patent Document 1) describes an imaging apparatus which subjects an electric signal obtained by A/D converting an output signal from the image pickup device to a color interpolation process, a matrix correction, a γ correction and a color conversion process from R, G and B to Y, Cr and Cb in a color processing block, compresses an image data in a JPEG processing block and stores the compressed data in a card memory.

The above development and compression are accompanied by a heavy load of calculating process. For this reason, performing the development and compression in a conventional manner in the DSC as the imaging apparatus increases a load of the processes in the DSC.

As the development and compression, there exist a variety of methods that are suitable for the photographed image or a user desires. In general, in the DSC, the development and compression are often performed by a fixed method with an image engine such as an LSI mounted on a model of the DSC. If the development and compression are given an option, the user needs to have a DSC on which a plurality of rear blocks with the color processing block and the JPEG processing block is mounted, so that the option is less realistic for the user who has not the DSC on which a plurality of rear blocks is mounted.

### SUMMARY

An advantage of some aspects of the invention is to provide an image processing system and an image processing apparatus capable of decreasing a load of process in an apparatus with an image pickup function and meeting the demand of a user by providing the process with many options and flexibility in a process for creating an image file.

In a first image processing apparatus forming an image processing system according to an aspect of the invention, a raw image data creating unit creates a raw image data by converting an image captured by an image pickup device to an electric signal on a pixel by pixel basis. An image file creating unit is capable of creating an image file conforming to a predetermined format based on the created raw image data. A control unit determines based on a predetermined criterion whether an external apparatus is caused to execute at least part of a process for creating the image file based on the raw image data, outputs the raw image data or processed data obtained when the image file creating unit is caused to execute the process halfway to the external apparatus if the control unit determines that the external apparatus is caused to execute it, and causes the image file creating unit to execute creating the image file if the control unit determines that the external apparatus is not caused to execute it. A second image processing apparatus as the external apparatus forming the image processing system receives the raw image data or the halfway processed data outputted from the first image processing apparatus and creates an image file conforming to a predetermined format based on the raw image data or the halfway processed data. Thus, according to the present invention, since the first image processing apparatus can cause the second image processing apparatus to execute a process required for creating the image file, a load of a process in the first image processing apparatus is substantially reduced. Even if the processes of the image file creation which the image file creating unit of the first image processing apparatus can execute are inflexible, providing the process with diversified options in a process for creating an image file enables creating an image file subjected to an optimum processing desired by the user as an entire system.

As one example of the invention, the control unit may determine that the second image processing apparatus is caused to execute at least part of the process of creating the image file if the raw image data creating unit is creating the raw image data with the first image processing apparatus communicably connected to the second image processing apparatus. In other words, as described above, the first image processing apparatus causes the second image processing apparatus to execute creating the image file if the first image processing apparatus is already communicably connected to the second image processing apparatus when the first image processing apparatus performs a series of processes related to image pickup. In this case, the user connects the first image processing apparatus to the second image processing apparatus and merely operates the first image processing apparatus, thereby causing the second image processing apparatus to create the image file.

As one example of the invention, the control unit may determine a state where an operation mode is set in the second image processing apparatus through communication with the second image processing apparatus, and if the second image processing apparatus is placed in a mode in which an image file can be created, the control unit determines that the second image processing apparatus is caused to execute at least part of a process for creating the image file. According to the configuration, even if the second image processing apparatus is connected to the first image processing apparatus and if the second image processing apparatus is placed in a mode except a mode in which an image file can be created, the image file is created by the first image processing apparatus instead of by the second image processing apparatus, so that the creation of the image file does not fall into arrears.

As one example of the invention, the control unit determines whether the second image processing apparatus is executing creating the image file through communication with the second image processing apparatus, and if the second image processing apparatus is not executing creating the image file, the control unit may determine that the second image processing apparatus is caused to execute at least part of a process for creating the image file. According to the configuration, even if the second image processing apparatus is connected to the first image processing apparatus and if the second image processing apparatus is already executing creating the image file, the image file is created by the first image processing apparatus instead of by the second image processing apparatus, so that the creation of the image file does not fall into arrears.

As one example of the invention, if the second image processing apparatus is caused to execute at least part of a process for creating the image file, the control unit determines that the second image processing apparatus is caused to execute which step in the process according to information as to a situation of the second image processing apparatus and may output data obtained at steps before the determined step to the second image processing apparatus. According to the configuration, it can be determined, according to information as to a situation of the second image processing apparatus (for example, the kind and processing capacity of a model), that the second image processing apparatus is caused to execute which step in the process for creating the image file based on a raw image data. This prevents the inconvenience that the second image processing apparatus being caused to execute a large amount of processes results in significant reduction in the speed of the image file creation.

The process for creating the image file may include at least a color interpolation process for interpolating color information of an element color lacking in each pixel of the raw image data based on color information of the element color of ambient pixels. In general, the color interpolation process is heavy in a load, so that the second image processing apparatus is caused to execute the process including the color interpolation process substantially reduces a burden on the side of the image processing apparatus.

Although the technical concept of the invention is described with reference to the image processing system formed of the first and the second image processing apparatus, it is to be understood that each apparatus forming the system also holds as a useful invention. As the invention corresponding to the first image processing apparatus, for example, there is provided an image processing apparatus including: a raw image data creating unit for converting an image captured by an image pickup device to an electric signal on a pixel by pixel basis to create a raw image data; an image file creating unit capable of creating an image file conforming to a predetermined format based on the created raw image data; and a control unit for determining based on a predetermined criterion whether an external apparatus is caused to execute at least part of a process for creating the image file based on the raw image data, outputting the raw image data or halfway processed data obtained when the image file creating unit is caused to execute the process halfway to the external apparatus, instructing the external apparatus to create the image file based on the raw image data or the halfway processed data if the control unit determines that the external apparatus is caused to execute it, and causing the image file creating unit to execute creating the image file if the control unit determines that the external apparatus is not caused to execute it.

Furthermore, as the invention corresponding to the second image processing apparatus, for example, there is provided an image processing apparatus including an image file creating unit capable of creating an image file conforming to a predetermined format based on the raw image data created by converting an image captured by an image pickup device to an electric signal on a pixel by pixel basis, wherein if the image file creating unit receives the raw image data or halfway processed data in a state where data has already been subjected to processes halfway through the process for creating an image file by an external apparatus based on the raw image data from the communicably connected external apparatus, the image file creating unit creates the image file based on the inputted raw image data or halfway processed data.

The invention holds true for a method having a processing step corresponding to each portion of the above image processing system and the image processing apparatus and a program causing a computer to execute the function corresponding to each portion of the above image processing system and the image processing apparatus.

### BRIEF DESCRIPTION OF THE DRAWINGS

FIG. 1 is a block diagram illustrating one example of a general configuration of an image processing system;

FIG. 2 is a flow chart illustrating one example of a process executed by the control unit of a DSC;

FIG. 3 is a flow chart illustrating one example of a determination process executed by the control unit of the DSC;

FIG. 4 is a block diagram illustrating one example of process by an image file creating unit of the DSC;

FIG. 5 is a chart describing how to detect an edge pattern;

FIG. 6 is a flow chart illustrating one example of a process executed by the control unit of a PSV;

FIG. 7 is a block diagram illustrating one example of a function of an image file creating unit of the PSV; and

FIG. 8 is a block diagram illustrating another example of process by the image file creating unit of the DSC.

### DESCRIPTION OF EXEMPLARY EMBODIMENTS

The embodiments of the present invention are described below with reference to the accompanied drawings in the following order:

1. General Configuration of an Image Processing System

2. An Image File Creating Process

3. Modifications

1. General Configuration of an Image Processing System

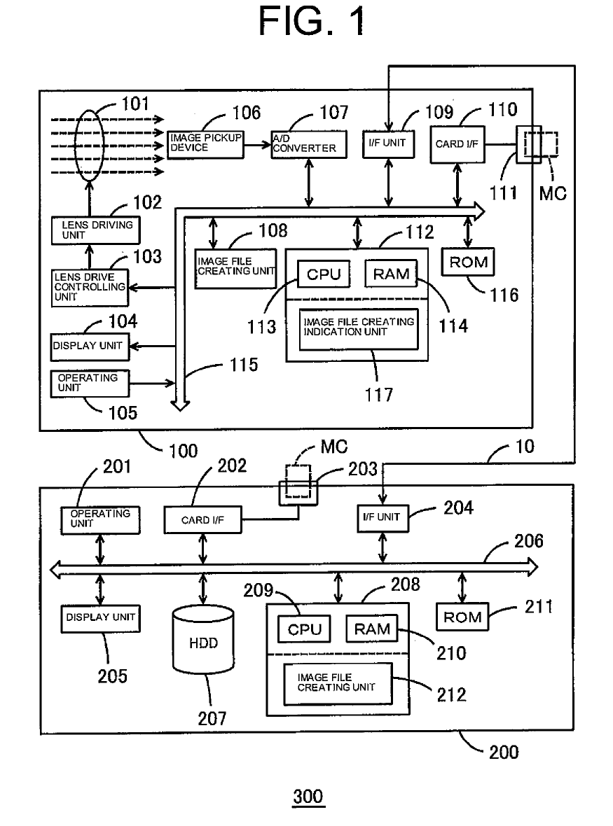

FIG. 1 is a block diagram illustrating a general configuration of an image processing system 300 according to the present embodiment.

The image processing system 300 is mainly formed of a digital still camera (DSC) 100 as an imaging apparatus and a photo storage viewer (PSV) 200. The DSC 100 and the PSV 200 correspond to a sole image processing apparatus. The DSC 100 corresponds to one example of a first image processing apparatus of the present invention. The PSV 200 corresponds to one example of a second image processing apparatus of the present invention. Incidentally, the DSC 100 corresponds to one of external apparatuses for the PSV 200.

As illustrated in FIG. 1, the DSC 100 includes a lens 101, a lens driving unit 102 for driving the lens 101 to adjust focal position and distance, a lens drive controlling unit 103 for controlling the lens driving unit 102, an image pickup device 106 for converting light incident on a light receiving surface through the lens 102 to an electric signal, an A/D converter 107 for analog-to-digital (A/D) converting the electric signal outputted from the image pickup device 106, an image file creating unit 108 for performing a predetermined development based on the data outputted from the A/D converter 107 to create an image file, an interface (I/F) 109 for transferring information with an external apparatus, a display unit 104 formed of a liquid crystal display driver and a liquid crystal display, an operating unit 105 formed of a button and a touch panel, a CPU 113, a RAM 114, a ROM 116 and a card interface (card I/F) 110.

The CPU 113 and the RAM 114 may be referred to as a control unit 112. The image pickup device 106 is formed of a single charge coupled device (CCD image sensor), for example. The light receiving surface is provided with a color filter in which one color out of prescribed element color (for example, red (R), green (G) and blue (B)) is arranged on a pixel basis. The card I/F 110 is an interface for transferring information with a memory card MC inserted into a card slot 111. The components of the DSC 100 are connected together through a bus 115.

In the control unit 112, the CPU 113 executes various programs stored in a storage medium such as the ROM 116 while using the RAM 114 as a work area to control each component of the DSC 100. In the present embodiment, the ROM 116 stores an image file creating indication unit 117 being a computer program. The CPU 113 reads the program from the ROM 116 to execute it, realizing the function of the image file creating indication unit 117. The process in the DSC 100 is described in detail later.

On the other hand, the PSV 200 includes an operating unit 201 formed of a button and a touch panel, a card I/F 202, an I/F unit 204 for transferring information with an external apparatus, a display unit 205 formed of a liquid crystal display driver and a liquid crystal display, a hard disk driver (HDD) 207, a CPU 209, a RAM 210 and a ROM 211. The CPU 209 and the RAM 210 may be referred to as a control unit 208. The card I/F 202 is an interface for transferring information with a memory card MC inserted into a card slot 203. The components of the PSV 200 are connected together through a bus 206.

In the control unit 208, the CPU 209 executes various programs stored in storage media such as the ROM 211 and a HDD 207 while using the RAM 210 as a work area to control each component of the PSV 200. In the present embodiment, the RON 211 stores an image file creating unit 212 being a computer program. The CPU 209 reads the program from the ROM 211 to execute it, realizing the function of the image file creating unit 212. The process in the PSV 200 is described in detail later.

For example, the I/F unit 109 is connected to the I/F 204 with a cable 10 (for example, a USB cable) conforming to a predetermined communication standard to communicably connect the DSC 100 to the PSV 200. The PSV 200 is an apparatus capable of loading a data file such as still picture, moving picture and music produced by an external apparatus into the built-in HDD 207 through the memory card MC or the cable 10 and causes the display unit 205 to display an image or a loudspeaker (not shown) to output sound based on the loaded data file.

2. An Image File Creating Process

The following is a description of an image file creating process using the image processing system 300 with the above configuration in the present embodiment.

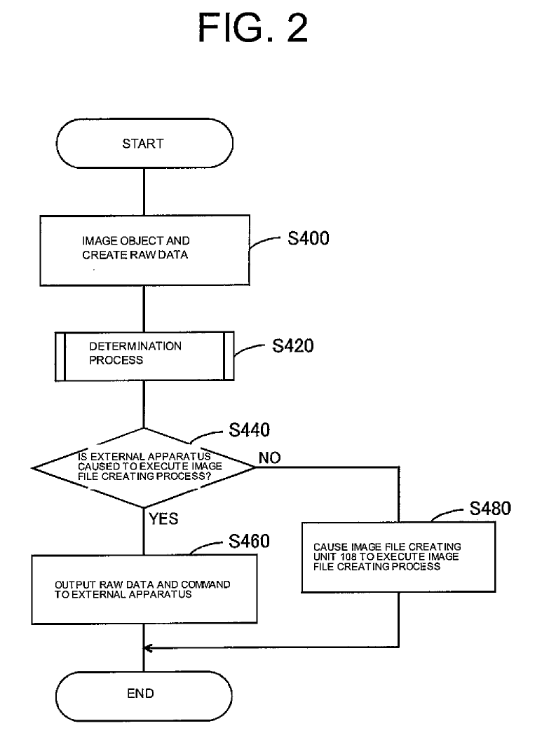

FIG. 2 is a flow chart illustrating one example of a process executed under the control unit 112 of a DSC 100. At step S400 (hereinafter “step” is omitted), as soon as the control unit 112 detects the user's operation of an imaging button (a shutter button), which is not shown, the control unit 112 causes the DSC 100 to image an object and create raw image data (RAW data). In other words, the control unit 112 controls the lens 101, the lens driving unit 102 and the lens drive controlling unit 103 to perform auto-focus, identify a main object and image it. At this point, the control unit 112 causes the image pickup device 106 to output the electric signal photo-electrically converted thereby to the A/D converter 107 and the A/D converter 107 to convert the inputted electric signal to digital data. As a result, RAW data is created which directly digitizes color information captured by each pixel of the image pickup device 106.

For this reason, the configuration of the image pickup device 106, the A/D converter 107 and the control unit 112 corresponds to a raw image data creating unit.

At S420, the control unit 112 determines according to a predetermined criterion whether an external apparatus is caused to execute an image file creating process based on the created RAW data. The determination process is performed by the CPU 113 realizing the function of the image file creating indication unit 117. When the DSC 100 picks up an image, the image file creating process is generally conducted also in the DSC 100, however, in the present embodiment, part of the processes that the DSC 100 can execute is taken over to the external apparatus under a certain condition.

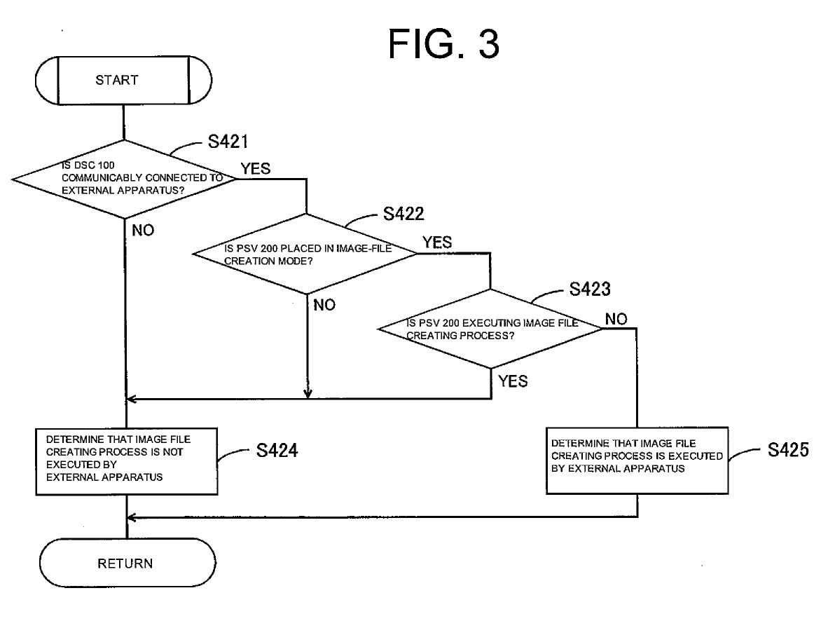

FIG. 3 is a detailed flow chart illustrating one example of the determination process at S420. At S421, as a first determination, the control unit 112 determines whether the DSC 100 is communicably connected to the external apparatus (PSV 200). For example, if the control unit 112 can detect the connection of the I/F unit 109 to the cable 10, the control unit 112 determines that the DSC 100 is communicably connected to the external apparatus (YES). In other words, if the image button is depressed and an image is picked up (i.e., RAW data is created) in a state where the DSC 100 is connected to the PSV 200 through the cable 10, it is determined “YES” at S421. If it is determined “YES” at S421, the control unit 112 causes the process to proceed to S422. If it is determined “NO” at S421, the control unit 112 causes the process to proceed to S424.

At S422, as a second determination, the control unit 112 determines the present setting of operation modes on the PSV 200 side to determine whether the PSV 200 is placed in a mode in which an image file can be created (or, in an image file creating mode). In the present embodiment, the user can select various modes such as a moving picture mode, still picture mode and music mode as well as the image file creating mode, on the PSV 200 side. Then, the control unit 112 issues a mode inquiry signal for inquiring the present setting of operation modes to the PSV 200 through the I/F unit 109, for example, to perform determination according to the kinds of the operation modes on the PSV 200 side indicated by a signal sent back from the PSV 200 in response to the mode inquiry signal. At S422, if the control unit 112 determines that the PSV 200 is placed in the image file creating mode (YES), the process proceeds to S423, if “NO,” the process proceeds to S424.

At S423, as a third determination, the control unit 112 determines whether the PSV 200 is executing the image file creating process. This is because, if the user continuously picks up an image, the PSV 200 may be executing the image file creating process based on the RAW data related to other images previously created. Then, the control unit 112 outputs an execution inquiry signal for inquiring of the PSV 200 whether the image file creating process is being executed though the I/F unit 109, for example, to perform determination according to a signal indicating whether the image file creating process is being executed and sent back in response to the execution inquiry signal At S423, if the control unit 112 determines that the PSV 200 is executing the image file creating process (YES), the process proceeds to S424, if “NO,” the process proceeds to S425.

At S424, the control unit 112 determines that the image file creating process based on the RAW data created at S400 is not executed by the external apparatus (i.e., executed by the DSC 100). On the other hand, at 5425, the control unit 112 determines that the image file creating process based on the RAW data created at S400 is executed by the external apparatus.

In FIG. 2, after the determination process has been finished at S420, the control unit 112 causes the process to branch based on the result of the determination process into S460 if the image file creating process is executed by the external apparatus and S480 if the image file creating process is not executed by the external apparatus (S440).

At S460, the control unit 112 causes the I/F unit 109 to output the RAW data outputted from the A/D converter 107 and a command instructing the external apparatus to execute the image file creating process based on the RAW data to the external apparatus (PSV 200). In that case, the RAW data outputted to the external apparatus is not such that all the data forming one image are filed, but such that data digitized by the A/D converter 107 is sequentially outputted in units of the predetermined number of pixels (for example, on a line basis). The process of the external apparatus (PSV 200) to which the RAW data is outputted is described later.

At S480, the control unit 112 inputs the RAW data outputted from the A/D converter 107 to the image file creating unit 108 in the DSC 100. The control unit 112 instructs the image file creating unit 108 to execute the image file creating process based on the RAW data and a series of processes for storing the created image file. In the present embodiment, the image file creating unit 108 is a kind of an image engine formed of an LSI and the like. The image file creating unit 108 is capable of creating various image file formats. The creation of the JPEG format image file should be designated by the user herein.

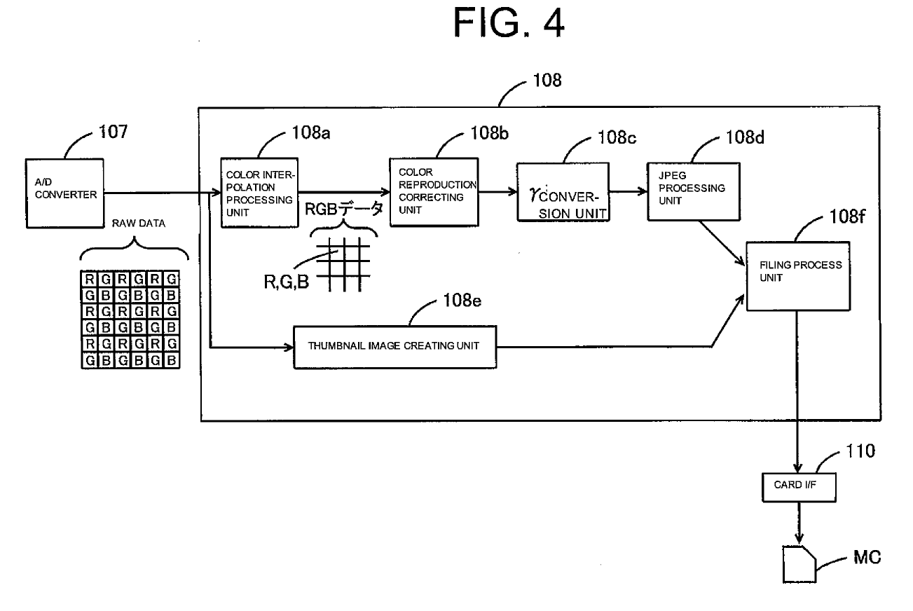

FIG. 4 is a block diagram illustrating one example of process mainly performed by the image file creating unit 108 in the DSC 100. The process is performed according to the instruction at S480.

In general, the RAW data obtained as an output result from the A/D converter 107 when a single CCD is used as the image pickup device 106 is such that each pixel has only color information (gradation value) of one element color. When a Bayer color filter is used, as illustrated in FIG. 4, the RAW data is such that a pixel having only a gradation value of G is arranged in a checkerboard pattern and pixels each having only a gradation value of R and a gradation value of B are arranged in a space between the pixels of G.

In the image file creating unit 108, a color interpolation processing unit 108a executes a color interpolation process (also referred to as de-mosaic processing) for interpolating the color information (gradation value) of an element color lacking in each pixel of the RAW data based on the gradation value of element color of an ambient pixel and the RGB data in which each pixel has gradation values of RGB are created. If a simple method is used for the color interpolation process and an element color lacking in a pixel of interest is interpolated, a value in which a gradation value of the element color of other pixels within the range of a predetermined size surrounding the pixel of interest is averaged may be taken as a gradation value of the element color in the pixel of interest. However, such a simple average color-interpolation may not provide picture quality which the user satisfies, such as picture quality sharp in edge. When the color interpolation processing unit 108a performs a color interpolation process, the color interpolation processing unit 108a detects an edge pattern around the pixel (pixel of interest) to be processed in the RAW data, determines a weighting factor for each pixel according to the detected edge pattern and performs a weighting accumulation of the gradation value of an ambient pixel using the determined weighting factor, thereby the gradation value of the element color lacking in the pixel of interest is obtained.

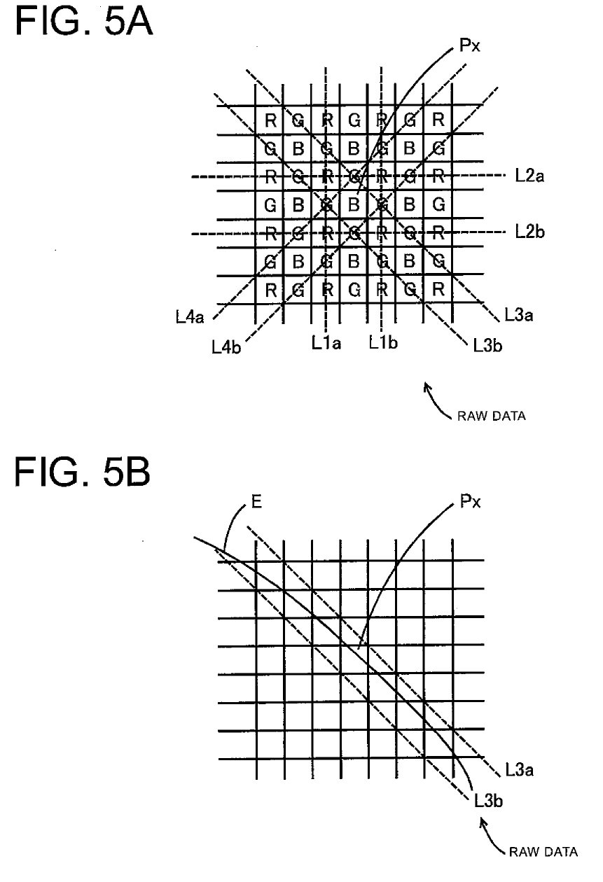

FIG. 5 is a chart illustrating one example of detecting an edge pattern around the pixel of interest by the color interpolation processing unit 108a. In the figure, if the pixel B in the center is taken as an pixel of interest Px, the color interpolation processing unit 108a calculates the sum of gradation values of G in the pixel columns through which two lines L1a and L1b extending upward and downward on the left and the right of the pixel of interest Px pass on a line L1a and a line L1b basis and determines a difference D1 between the sum of G with respect to the line L1a and the sum of G with respect to the line L1b. Similarly, the color interpolation processing unit 108a calculates the sum of gradation values of G in the pixel rows through which two lines L2a and L2b extending leftward and rightward on the upper and the down side of the pixel of interest Px pass on a line L2a and a line L2b basis and determines a difference D2 between the sum of G with respect to the line L2a and the sum of G with respect to the line L2b. Furthermore, the color interpolation processing unit 108a calculates the sum of gradation values of the pixels G through which two lines L3a and L3b extending from the upper left to the lower right corner at an angle of 45 degrees with the pixel of interest Px between the lines L3a and L3b pass on a line L3a and a line L3b basis and determines a difference D3 between the sum of G with respect to the line L3a and the sum of G with respect to the line L3b. Still furthermore, the color interpolation processing unit 108a calculates the sum of gradation values of the pixels G through which two lines L4a and L4b extending from the upper right to the lower left corner at an angle of 45 degrees with the pixel of interest Px between the lines L4a and L4b pass on a line L4a and a line L4b basis and determines a difference D4 between the sum of G with respect to the line L4a and the sum of G with respect to the line L4b.

The color interpolation processing unit 108a determines the differences D1 to D4 as described above, and then identifies the maximum value among the differences D1 to D4 and determines that an edge extends between the two lines (for example, the lines L3a and L3b) making the identified difference D (for example, the difference D3). In other words, determining the differences D1 to D4 finds out an edge pattern caused around the pixel of interest Px. After the edge pattern around the pixel of interest Px has been found out, the color interpolation processing unit 108a determines a weighting factor for pixels around the pixel of interest Px according to the found-out edge pattern. For example, if the difference D3 is the greatest and the sum of G with respect to the line L3a is smaller than the sum of G with respect to the line L3b, an edge pattern E separating a high gradation (bright) on the line L3a side from a low gradation (dark) on the line L3b side may be formed between the line L3a and the line L3b (refer to FIG. 5(b)). For this reason, the pixels around the pixel of interest Px are given such a weighting factor as further emphasizes the edge pattern E (for example, a weighting factor is increased for the pixels through which the line L3b passes and the pixels outside the line L3a).

The color interpolation processing unit 108a subjects all element colors lacking in all pixels of the RAW data to such a color interpolation process.

In the image file creating unit 108, a color reproduction correcting unit 108b applies a color reproduction correction to the RGB data outputted from the color interpolation processing unit 108a. The term “color reproduction correction” refers to a operation for obtaining color near human visual sensitivity from a spectral characteristic inherent in a color filter of the image pickup device 106 and conversion is performed, e.g., using a matrix operation, from ROB to RGB with respect to each pixel. In the image file creating unit 108, a γ (gamma) conversion unit 108c subjects the RGB data to which the color reproduction correction has been applied to a predetermined γ conversion to correctly reproduce gradation under the output characteristics of a prescribed output apparatus.

A JPEG processing unit 108d subjects the γ converted data to a compression process based on a predetermined compression format (JPEG compression). A filing process unit 108f creates a JPEG-format image file including data and additional information (header) for the compressed one image. The image file creating unit 108 also includes a thumbnail image creating unit 108e. The thumbnail image creating unit 108e creates thumbnail image data representing a thumbnail image (contracted image) based on the RAW data outputted from the A/D converter 107. The thumbnail image data is also added to the image file created by the filing process unit 108f.

The control unit 112 causes the image file creating unit 108 to output the image file to the card I/F 110 and the memory card MC to store the image file through the card I/F 110. As a result, the image picked up by the use using the DSC 100 is stored in the memory card MC.

The following is a description of process of the PSV 200. As described above, if the DSC 100 selects the process of S460 instead of the process of S480, the DSC 100 outputs the RAW data and the command instructing the PSV 200 to execute the image file creating process based on the RAW data to the PSV 200.

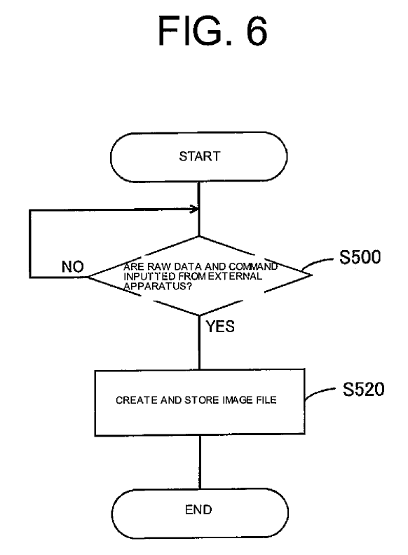

FIG. 6 is a flow chart illustrating one example of a process executed under the control of the control unit 208. The process is performed mainly by the CPU 209 realizing the function of the image file creating unit 212.

At S500, the control unit 208 determines whether the RAW data and the command are inputted from the external apparatus (the external apparatus for the PSV 200), and if it determines that the RAW data and the command are inputted, the process proceeds to the S520. In this case, the control unit 208 monitors the input to the I/F unit 204 at a predetermined timing, for example, and if the control unit 208 detects the RAW data and the command through the I/F unit 204, the process proceeds to S520.

At S520, the control unit 208 executes the creation of the image file based on the RAW data and the storage of the created image file according to the command.

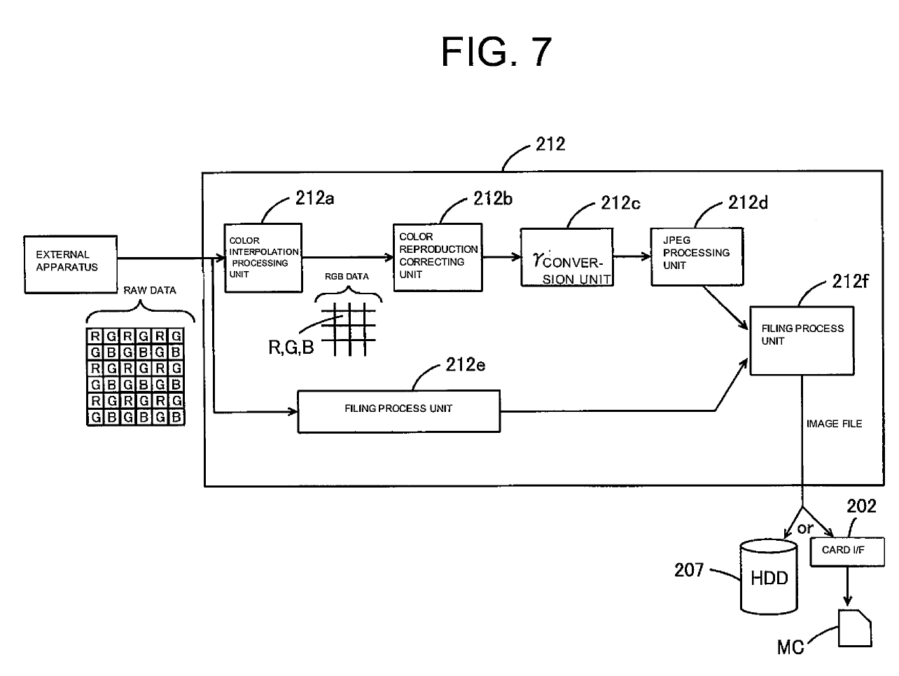

FIG. 7 is a block diagram illustrating the function of an image file creating unit 212 realized by the CPU 209 at S520. As illustrated in FIG. 7, the image file creating unit 212 includes a color interpolation processing unit 212a, a color reproduction correcting unit 212b, a γ conversion unit 212c, a JPEG processing unit 212d, a thumbnail image creating unit 212e and a filing process unit 212f. That is to say, in the PSV 200, the image file creating unit 212 having the same function as the image file creating unit of the DSC 100 enables creating a image file conforming to a predetermined image format (JPEG) based on the RAW data supplied from the DSC 100. The functions of the color interpolation processing unit 212a, the color reproduction correcting unit 212b, the γ conversion unit 212c, the JPEG processing unit 212d, the thumbnail image creating unit 212e and the filing process unit 212f are the same as those in the image file creating unit 108 of the DSC 100, so that description thereof is omitted. The control unit 208 outputs the image file created by the filing process unit 212f to a HDD 207 or a card I/F 202 to store the image file in the HDD 207 or a memory card MC inserted into a card slot 203.

Thus, according to the present embodiment, such processes primarily conducted by the DSC 100 as the creation and storage of image files based on the RAW data created by imaging can be executed by the PSV 200 depending on a situation where the DSC 100 is connected to the PSV 200 as the external apparatus and the PSV 200 is operated. Consequently, a load of the processes on the DSC 100 side can be substantially decreased. In particular, a color interpolation process is heavy in a load in the processes of image file creation to require a large number of resources. However, the PSV 200 is caused to execute development including such a color interpolation process to effectively decrease a load of the processes on the DSC 100 side. Since a determination and a process in which if the PSV 200 is in a situation where it can execute an image file creation, it is caused to execute it, or if the PSV 200 is in a situation where it cannot execute the image file creation, the DSC 100 executes it instead are performed each time the user picks up an image, a load of the process on the DSC 100 side can be decreased at the time of a continuous imaging.

One of the advantages that causes the PSV 200 as the external apparatus to perform the image file creating process primarily conducted by the DSC 100 is that a concrete content of the image file creating process can be provided with flexibility. That is to say, in the DSC 100, the LSI (the image file creating unit 108) as an image engine mounted on the DSC 100 executes the image file creation, so that methods and parameters of each process such as the color interpolation process and color reproduction correcting process in the image file creating process tend to be fixed. On the other hand, in the PSV 200, the program of the image file creating unit 212, for example, is properly upgraded in order to realize the creation of the image file by the function of the image file creating unit 212 as a software (a computer program) to allow flexibly changing methods and parameters of the color interpolation process and color reproduction correcting process. According to the present embodiment, even if the image file creating process which can be executed by the DSC 100 of the user is inflexible, the external apparatus of the DSC 100 is caused to execute the image file creating process, enabling the image file creating process to be provided with selectivity and flexibility, thereby allowing meeting a user's need.

3. Modifications

The foregoing embodiment is one example of the present invention. In addition to the one example, various embodiments are conceivable.

In the description of the flow chart in FIG. 3, if it is determined “YES” at S423, the control unit 112 determines that the image file creating process based on the RAW data is not executed by the external apparatus. However, as another embodiment, if it is determined “YES” at S423, the control unit 112 repetitively inquires of the PSV 200 whether the image file creating process is being executed and places a determination process in a temporal standby state until the control unit 112 receives a signal indicating that the image file creating process has been finished (i.e., a signal indicating that the image file creating process is not being executed) from the PSV 200. When the control unit 112 receives the signal indicating that the image file creating process has been finished, the process proceeds to S425 and the control unit 112 may determine that the external apparatus is caused to execute the image file creating process. As still another embodiment, if it is determined “YES” at S423 and the control unit 112 determines that the image file creating process is not executed by the external apparatus (S424), the control unit 112 repetitively inquires of the PSV 200 whether the image file creating process is being executed, in parallel with S440 and S480. When the control unit 112 receives the signal indicating that the image file creating process has been finished from the PSV 200, the control unit 112 may output the image file created by the image file creating unit 108 to the PSV 200 and store it in the storage medium (the HDD 207 or the memory card MC inserted into the card slot 203).

Such a configuration enables the image file to be stored on the PSV side without troubling the user even if it is determined “YES” at S423.

In the above embodiment, when the image file creating process is executed by the PSV 200, the PSV 200 was caused to execute the entire process for creating the image file from the RAW data. However, the control unit 112 may cause the PSV 200 to execute only a part of such a process. Specifically, even if the control unit 112 determines that the external apparatus is caused to execute the image file creating process at S440 and the process proceeds to S460, the control unit 112 inputs the RAW data outputted from the A/D converter 107 to the image file creating unit 108 in the DSC 100 at S460 and the image file creating unit 108 to execute the image file creating process halfway through the entire process. The control unit 112 causes the I/F unit 109 to output data obtained when the image file creating process is executed halfway through the entire process (halfway processed data) and a command instructing the external apparatus to execute the image file creating process based on the halfway processed data to the external apparatus (PSV 200).

The halfway processed data corresponds to data subjected to the color interpolation process by the color interpolation processing unit 108a, data subjected to the color reproduction correction by the color reproduction correcting unit 108b and data subjected to the γ conversion by the γ conversion unit 108c. In the PSV 200 received the halfway processed data, the control unit 208 subjects the data to processes subsequent to the halfway process to create the image file, such as the color reproduction correction by the color reproduction correcting unit 212b, the γ conversion by the γ conversion unit 212c and the compression process by the JPEG processing unit 212d according to a status of the halfway processed data (i.e., the data has been subjected to which process) to finally complete the creation of an image file.

At this point, the control unit 112 may determine that the PSV 200 is caused to execute the image file creation at which step in the entire process where the image file is created from the RAW data, according to information as to a situation of the PSV 200. The information as to a situation of the PSV 200 refers to, for example, the model of the PSV 200 and a predetermined information indicating the capacity of the color interpolation process in the PSV 200. For example, at S460, the DSC 100 requests the PSV 200 to supply information as to the model thereof and then determines that the PSV 200 is caused to execute the image file creation at which step in the entire process, according to the information as to the model thereof notified in response to the request. For example, if the information as to the model indicates that the model is somewhat earlier in a manufacturing time, the DSC determines that the model is low in a processing capacity (slow in a processing speed) and entrusts the PSV 200 with the γ conversion and following processes without entrusting it with the entire process. Furthermore, at S460, for example, the DSC 100 obtains the updated information as to the image file creating unit 212 as a software stored in the PSV 200 from the PSV 200 to determine time required for processing feasible for the image file creating unit 212 and the degree of an available picture quality based on the updated information and performs a determination that the PSV 200 is entrusted with the color reproduction correction and following processes without entrusting it with the entire process.

The control unit 112 causes the image file creating unit 108 to create the halfway processed data corresponding to the data created at the steps before the step thus determined and outputs the created halfway processed data to PSV 200. Thus, the PSV 200 is caused to execute the process halfway through the entire process where the image file is created from the RAW data to enable realizing the creation of the image file in which process speed is compatible with picture quality. As a result, this prevents the inconvenience that the PSV 200 being caused to execute the image file creation in the entire process results in reduction in the process speed and the picture quality.

As another modification, a plurality of external apparatus maybe connected to the DSC 100. In FIG. 1, a single PSV 200 is illustrated, however, if a plurality of PSVs 200 are connected to the DSC 100 through the cable 10 together, for example, the present invention is also applicable. In this case, the control unit 112 of the DSC 100 performs a determination process (S420) as to whether an external apparatus is caused to execute the image file creation process based on the RAW data as described below. The control unit 112 detects all PSVs 200 communicably connected thereto and identifies the PSV 200 in which the operation mode is presently placed in the image file creating mode among the detected PSVs 200. The control unit 112 preferentially selects the apparatus that is not executing the image file creating process at that point among the identified PSVs 200 and outputs the RAW data to the selected PSV 200. Such a configuration automatically selects the PSV 200 suitable for the destination of the RAW data for a single image to perform the creation of an image file each time the user continuously operates a shutter button to pick up an image. Accordingly, a continuous imaging using the DSC 100 is increased in speed.

As still another modification, the PSV 200 may be equipped with a different kind of the image file creating unit 212 in a predetermined storage medium such as the HDD 207 and the user selects a program used for the image file creating process from among a plurality of kinds of the image file creating units 212 and may set it. In that case, for example, the effect of edge enhancement of an image by the color interpolation process, the effect of the color reproduction correction and the image file creating unit 212 different in process speed are stored in the HDD 207. In prior to imaging using the DSC 100, the user operates the operating unit 201 of the PSV 200 to select one kind of program from among a plurality of kinds of the image file creating units 212. When the control unit 208 receives the RAW data supplied from the external apparatus (DSC 100), the CPU 209 reads and executes the selected program (the image file creating unit 212). Thus, providing the PSV 200 with a different kind of the image file creating unit 212 enables performing the image file creating process meeting a user's need.

There is described above an example where a picked-up image is stored in the DSC 100 and the PSV 200 as a JPEG image file. However, as a format used in storing images in the DSC 100 and the PSV 200, there may be used various formats such as TIFF format and the like as well as the JPEG. The picked-up image remaining the RAW data may be stored.

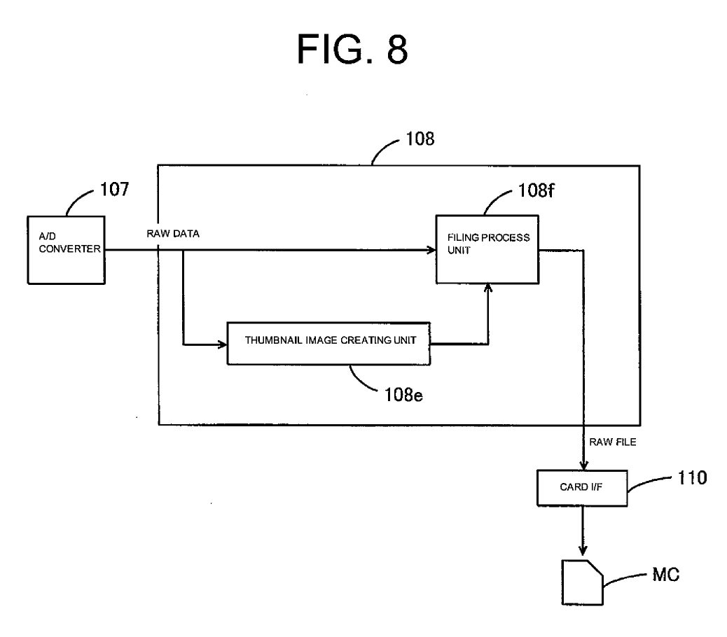

FIG. 8 is a block diagram illustrating a process by the image file creating unit 108 in a case where an image is stored as the RAW data in the DSC 100. If the control unit 112 of the DSC 100 determines that the external apparatus is not caused to execute the image file creating process and the image remaining the RAW data is stored (in a case where the image being stored as the RAW data is set by user's operation of the operating unit 105), at S480, the RAW data outputted from the A/D converter 107 is outputted to the image file creating unit 108. In the image file creating unit 108, the thumbnail image creating unit 108e creates thumbnail image data based on the outputted RAW data and the filing process unit 108f combines the created thumbnail image data and the RAW data for a single image to file them. The control unit 112 stores the file (RAW file) in the memory card MC through the card I/F 110. It is needless to say that the image can be stored as the RAW data also on the PSV 200 side. In other words, if the control unit 112 of the PSV 200 is instructed by the DSC 100 to store an image remaining the RAW data, the control unit 112 combines the RAW data supplied from the DSC 100 and the thumbnail image data created based on the RAW data to create the RAW file, storing the created RAW file in the HDD 207 and the memory card MC.

In the above description, although a cable 10 is used to communicate between the image processing apparatus (the DSC 100 and the PSV 200) forming the image processing system 300, radio may be used to communicate between the image processing apparatus.

In the above description, although the PSV 200 is taken as an example of the second image processing apparatus, various apparatus as well as the PSV 200 may be used as the second image processing apparatus, for example, a printer may be used as the second image processing apparatus. When the printer is used as the second image processing apparatus, the printer needs to have functions of creating the image file based on the RAW data and the halfway processed data supplied from the DSC 100, storing the created image file and printing an image based on the created image file, as is the case with the PSV 200. Furthermore, a projector may be used as the second image processing apparatus. In this case, the projector needs to have functions of creating the image file based on the RAW data and the halfway processed data supplied from the DSC 100, storing the created image file and projecting an image based on the created image file on a screen.

The above embodiments and modifications may be properly combined together and executed. The present invention is not limited to the above embodiments and modifications but can be implemented in various forms without deviating from the gist thereof.

While the invention has been particularly shown and described with respect to preferred embodiments thereof, it should be understood by those skilled in the art that the foregoing and other changes in form and detail may be made therein without departing from the spirit and scope of the invention as defined in the appended claims.

What is claimed is:

1. An image processing system comprising:
a first image processing apparatus including
a raw image data creating unit for converting an image captured by an image pickup device to an electric signal on a pixel by pixel basis to create a raw image data,
an image file creating unit capable of creating an image file conforming to a predetermined format based on the created raw image data, and
a control unit for determining based on a predetermined criterion whether an external apparatus is caused to execute at least part of a process for creating the image file based on the raw image data, outputting the raw image data or halfway processed data obtained when the image file creating unit is caused to execute the process halfway to the external apparatus if the control unit determines that the external apparatus is caused to execute it, and causing the image file creating unit to execute creating the image file if the control unit determines that the external apparatus is not caused to execute it; and
a second image processing apparatus as the external apparatus for receiving the raw image data or the halfway processed data outputted from the first image processing apparatus and creating an image file conforming to a predetermined format based on the raw image data or the halfway processed data.

2. The image processing system according to claim 1, wherein
the control unit determines that the second image processing apparatus is caused to execute at least part of the process of creating the image file if the raw image data creating unit is creating the raw image data with the first image processing apparatus communicably connected to the second image processing apparatus.

3. The image processing system according to claim 2, wherein
the control unit determines a state where an operation mode is set in the second image processing apparatus through communication with the second image processing apparatus, and if the second image processing apparatus is placed in a mode in which an image file can be created, the control unit determines that the second image processing apparatus is caused to execute at least part of a process for creating the image file.

4. The image processing system according to claim 2, wherein
the control unit determines whether the second image processing apparatus is executing creating the image file through communication with the second image processing apparatus, and if the second image processing apparatus is not executing creating the image file, the control unit determines that the second image processing apparatus is caused to execute at least part of a process for creating the image file.

5. The image processing system according to claim 1, wherein
if the second image processing apparatus is caused to execute at least part of a process for creating the image file, the control unit determines that the second image processing apparatus is caused to execute which step in the process according to information as to a situation of the second image processing apparatus and outputs data obtained at steps before the determined step to the second image processing apparatus.

6. The image processing system according to claim 1, wherein
the process for creating the image file includes at least a color interpolation process for interpolating color information of an element color lacking in each pixel of the raw image data based on color information of the element color of ambient pixels.

7. An image processing apparatus comprising:
a raw image data creating unit for converting an image captured by an image pickup device to an electric signal on a pixel by pixel basis to create a raw image data;
an image file creating unit capable of creating an image file conforming to a predetermined format based on the created raw image data; and
a control unit for determining based on a predetermined criterion whether an external apparatus is caused to execute at least part of a process for creating the image file based on the raw image data, outputting the raw image data or halfway processed data obtained when the image file creating unit is caused to execute the process halfway to the external apparatus, instructing the external apparatus to create the image file based on the raw image data or the halfway processed data if the control unit determines that the external apparatus is caused to execute it, and causing the image file creating unit to execute creating the image file if the control unit determines that the external apparatus is not caused to execute it.

8. An image processing apparatus comprising an image file creating unit capable of creating an image file conforming to a predetermined format based on the raw image data created by converting an image captured by an image pickup device to an electric signal on a pixel by pixel basis, wherein
if the image file creating unit receives the raw image data or halfway processed data in a state where data has already been subjected to processes halfway through the process for creating an image file by an external apparatus based on the raw image data from the communicably connected external apparatus, the image file creating unit creates the image file based on the inputted raw image data or halfway processed data.
